(19) United States
(12) Patent Application Publication
(10) Pub. No.: US 2021/0248523 A1
(43) Pub. Date: Aug. 12, 2021

(54) DISTRIBUTED LEDGER PLATFORM FOR TRACKING CROWDSOURCED AND INDIVIDUAL-BASED CARBON OFFSETS IN REAL TIME

(71) Applicant: Cascadia Carbon Inc., Portland, OR (US)

(72) Inventor: Alexander Wick, Portland, OR (US)

(21) Appl. No.: 17/172,823

(22) Filed: Feb. 10, 2021

Related U.S. Application Data
(60) Provisional application No. 62/995,661, filed on Feb. 10, 2020.

(51) Int. Cl. G06Q 10/06; G06N 20/00; G06Q 50/26

(52) U.S. Cl. CPC G06Q 10/063; G06Q 50/26; G06N 20/00

(57) ABSTRACT

Methods and systems for tracking individual-based carbon offsets in real time using a distributed ledger are presented. One method includes: tracking, by a computing device having one or more processors, the movement of a user device associated with a user from a first location; receiving, via sensors on the user device, motion-specific data for a predetermined duration; creating feature vectors using the motion-specific data for the predetermined duration; applying a trained machine learning model to the feature vectors to determine a mode of transport for the movement; receiving by the computing device, an indication of the end of the movement at a second location; generating, based on the mode of transport, a carbon offset score; and recording, in a distributed ledger, a tokenized entry of the carbon offset score.

### RELATED APPLICATIONS

This application claims priority to U.S. Provisional Application No. 62/995,661 filed Feb. 10, 2020, the entire disclosure of which is hereby incorporated herein by reference in its entirety.

### TECHNICAL FIELD

Certain aspects of the present disclosure generally relate to a distributed ledger platform, and particularly to distributed ledger platforms for tracking crowdsourced and individual-based carbon offsets in real time.

### BACKGROUND

Climate change is an existential problem for society and the planet. Carbon dioxide emissions from fossil-fuels pose a grave threat to the continued existence of society. Carbon is increasingly being regulated by governments, usually by a value that is placed on its emission as a pollutant. Carbon offsets, e.g., via carbon credits, have become a way of reducing society's overall impact on the environment. Historically, carbon credits were assigned to business entities when they went “above and beyond business-as-usual standards” to offset carbon emissions. There is a need to better track and reward individual efforts towards offsetting carbon emissions.

Various embodiments of the present disclosure address one or more of the shortcomings presented above.

### SUMMARY

The present disclosure presents new and innovative methods and systems for tracking individual-based carbon offsets in real time using a distributed ledger. In one embodiment, a method is provided that involves a computing device having one or more processors (e.g., a carbon offset tracking server) receiving, from a user device associated with a user, an indication of a movement from a first location of the user device; initiating, via sensors of the user device, tracking of the movement from the identified first location; receiving, by the computing device via the sensors, motion-specific data for a predetermined duration; creating, by the computing device, one or more feature vectors using the motion-specific data for the predetermined duration; applying a trained machine learning model to the feature vectors to determine a mode of transport for the movement; receiving an indication of the end of the movement at a second location; generating, based on the mode of transport, a carbon offset score; and creating, in a new data structure of a distributed ledger, a tokenized entry of the carbon offset score, wherein the new data structure is linked to a previous data structure of the distributed ledger.

In another embodiment, a system is disclosed for tracking individual-based carbon offsets in real time using a distributed ledger. The system may comprise the distributed ledger, one or more processors; and memory. The memory stores instructions that, when executed by the processors, cause the system to: receive, from a user device associated with a first user, an indication of a movement from a first location of the user device; initiate, via sensors of the user device, tracking of the movement from the identified first location; receive, via the sensors, motion-specific data for a predetermined duration; determine a mode of transport for the movement; receive an indication of the end of the movement at a second location; generate, based on the mode of transport, a carbon offset score; and create, in a new data structure of the distributed ledger, a tokenized entry of the carbon offset score, wherein the new data structure is linked to a previous data structure of the distributed ledger.

In another embodiment, a non-transitory computer readable medium is disclosed for use on a computer system containing computer-executable programming instructions for tracking individual-based carbon offsets in real time using a distributed ledger. The instructions comprise one or more steps, methods, or processes described herein.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates a system for tracking individual-based carbon offsets in real time using a distributed ledger, according to an embodiment of the present disclosure.

FIG. 2 illustrates an a flow diagram of an example method of tracking individual-based carbon offsets in real time using a distributed ledger, according to exemplary embodiments of the present disclosure.

FIG. 3 illustrates a flow diagram of example methods for training and applying a machine learning model for tracking individual-based carbon offsets in real time, according to exemplary embodiments of the present disclosure.

FIG. 4 illustrates a flow diagram of an example method of tracking individual-based carbon offsets in real time using a distributed ledger, according to exemplary embodiments of the present disclosure.

### DETAILED DESCRIPTION OF EXAMPLE EMBODIMENTS

Carbon credits, used to reward efforts towards carbon offsets, have become a useful incentive for reducing a company's or an individual's overall impact on the environment. Historically, carbon credits were assigned to business entities when they went “above and beyond business-as-usual standards” to offset carbon emissions. There is a need to better track and reward individual efforts towards offsetting carbon emissions.

The present disclosure relates to systems and methods for tracking individual-based carbon offsets in real time using a distributed ledger. In one aspect, a software-based carbon offset generator is disclosed, which creates digital carbon offsets from alternative transportation and/or motility data recorded by the user device. Alternative transportation may include, but is not limited to, walking, running, bicycling, and other “micromobility” solutions such as e-scooters, e-bikes, as well as public transportation data. Blockchain and/or other distributed or shared ledger platforms may be used to store these carbon offsets, which may provide an immutable record of the production of carbon offsets/credits. Carbon offset data may be stored in distributed ledger platforms with the use of a directed acyclic graph schema, a low-energy blockchain protocol with elements of Proof of Space and/or elapsed time verification, and other methods of consensus, verification, trustless architecture, and byzantine fault tolerance.

Stored data regarding an individual's efforts towards carbon offsets can then be certified and sold to emitters, enterprise, individuals, on domestic markets, or open international markets. By utilizing a crowdsourcing model to create carbon offsets from quantifying individuals' “alternative transport” choices, stored individual-based carbon offset data can be aggregated form smaller sources, and sold as a quantified proof of carbon emissions being avoided (e.g., carbon credit). As used herein, “crowdsourcing” can include a sourcing model in which individual organizations obtain goods or services from the public at large. Crowdsourcing may divide work between participants to achieve a cumulative result.

In some aspects of the present disclosure, a crowdsourcing model is applied to combine individual efforts towards carbon offsets (e.g., through sensor data captured via user devices of the respective individuals) to create a composite of recorded carbon savings from hundreds, thousands, and/or potentially millions of users, e.g., as a result of transportation choices. Sensors from user devices can allow location and motility data to be tracked and recorded accurately, which may assure an accurate and reliable real time method of determining an individual's carbon offset contribution (e.g., a measurement of carbon emission that is avoided), and distributed or shared ledger platforms (e.g., blockchain) allows a verified and immutable storage of the resulting carbon offset contribution. Also or alternatively, shared ledger technology and their related spin-offs, such as directed acyclic graph technology can help to alleviate the “double-spend” problem of a distributed public ledger system, and may provide a suitable platform for storage and exchange of carbon offsets/credits. Furthermore, as individual- based carbon offset contributions are tracked and stored on to distributed ledger platforms, a crowdsourcing model may be used to pool a plurality of individual-based carbon offset contributions for various causes, e.g., creating a fungible carbon offset token such as a carbon credit.

Thus, what may be several pounds of carbon dioxide avoided per day per user, when chained together with other users that begin to utilize the systems and methods disclosed herein, can quickly become tons of carbon saved per day. By remaining publicly accessible, the distributed ledger platform disclosed herein may build trust in the system, and may allow carbon credits from the disclosed system to be sold as secure records of avoided emissions.

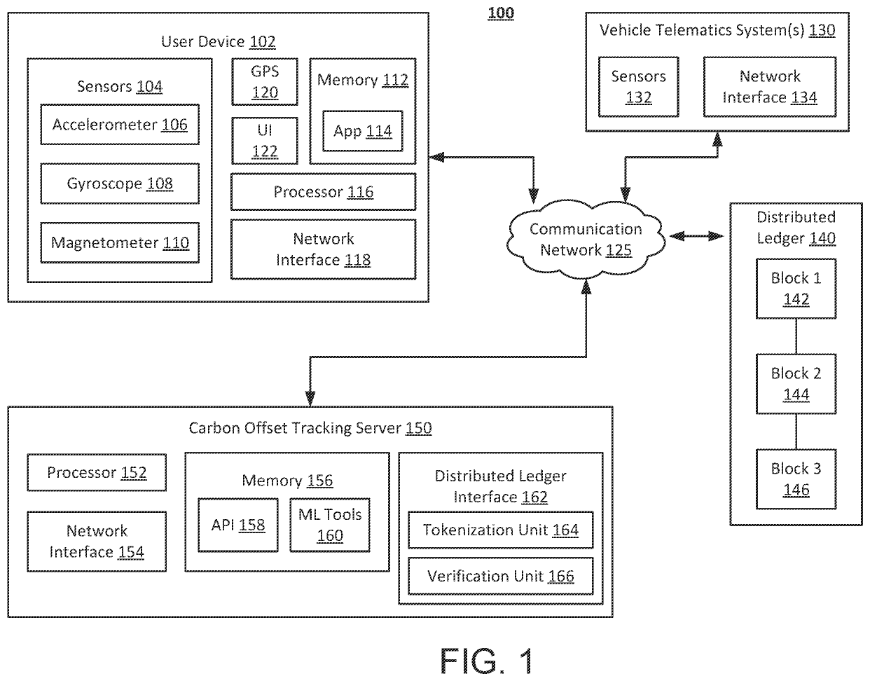

FIG. 1 illustrates a system 100 for tracking individual-based carbon offsets in real time using a distributed ledger, according to an embodiment of the present disclosure. The system 100 includes a user device 102 associated with a user, a vehicle telematics system 130 associated with a vehicle for providing mobility to the user, and a carbon offset tracking server 150. The carbon offset tracking server 150 may be able to access, store, and/or otherwise perform operations in a distributed ledger 140, e.g., as a node in a network associated with the distributed ledger 140. The distributed ledger 140 may, as a component of system 100, comprise a server, or as a decentralized but shred database structure that stores immutable blocks, as will be described further herein. Each of the above described components of the system may be able to communicate with one another over a communication network 125, which may be any wired or wireless network for disseminating information. Examples of the wireless networks may comprise Wi-Fi, a global system for mobile communications (GSM) network, and a general packet radio service (GPRS) network, an enhanced data GSM environment (EDGE) network, 802.5 communication networks, code division multiple access (CDMA) networks, Bluetooth networks or long term evolution (LTE) network, LTE-advanced (LTE-A) network or 5th generation (5G) network. Moreover, one or more of the system components may include a respective network interface (e.g., network interface 118, 134, and 154) to facilitate communication through the communication network 150. For example, the respective network interface may comprise a wired interface (e.g., electrical, RF (via coax), optical (via fiber)), a wireless interface, a, modem, etc. Furthermore, one or more of the above described system components may include one or more respective processor(s) (e.g., processor 116 and 152) and memory (e.g., memory 112 and 156) The processor may comprise any one or more types of digital circuit configured to perform operations on a data stream, including functions described in the present disclosure. The memory may comprise any type of long term, short term, volatile, nonvolatile, or other memory and is not to be limited to any particular type of memory or number of memories, or type of media upon which memory is stored. The memory may store instructions that, when executed by the processor, can cause the respective device to perform one or more methods discussed herein.

The user device 102 may be implemented as a computing device, such as a computer, smartphone, tablet, smartwatch, or other wearable through which an associated user can communicate with the carbon offset tracking server 150. The user device 102 may also be used to track user activities that help to offset carbon. For at least these reasons, the user device 102 may include a global positioning system 120 and/or one or more sensors 104, for example, accelerometer 106, gyroscope 108, and magnetometer 110. The user device 102 may further include a user interface (UI) 112, which may comprise a touch-sensitive display, a touchscreen, a keypad with a display device, a display screen or a combination thereof, to allow the user to access and use one or more applications 114, and enter input signals. The applications 114, which may be stored within memory 112, may comprise any program or software to perform the methods described herein. For example, the applications 16 may include an application hosted by the carbon offset tracking server 150 for tracking individual-based carbon offsets in real time using a distributed ledger. The user and/or the user device may have an identification (e.g., UUID) that the application 114 and/or the carbon offset tracking server 150 may use to track carbon offset contributions by the user and to enter such contributions in the distributed ledger 140.

In some aspects, the user may or the user device may engage in transportation or a motility activity that involves a vehicle. The vehicle may comprise or be associated with a vehicle telematics system 130. The vehicle telematics system 130 may comprise a computing system, device, and/or server that monitors one or more conditions or activities of the vehicle, e.g., through sensors 132 of the vehicle. The sensors 132 may include, for example, a GPS or location tracking device of the vehicle. Furthermore, the vehicle telematics system 130 may identify the vehicle, including information about the vehicle as it pertains to carbon emissions and/or offsets. The vehicle telematics system 130 may be detectable by the user device 102 as they are brought within close proximity.

The carbon offset tracking server 150 may comprise a local or a remote computing system for registering users that would like to participate in carbon offset contributions via their respective user devices; requesting and receiving information from the user device 102, including sensor data for tracking a carbon offsetting activities performed by the user; processing sensor data obtained from the user device 102; training and applying machine learning models, e.g., to identify modes of transport; generate carbon offset assessments and scores associated with users; accessing, encrypting, tokenizing, entering, and/or validating entries into the distributed ledger 140 pertaining to carbon offset contribution; and generating fungible tokens (e.g., carbon credit) based on a combination of carbon offset contributions.

The one or more processors 152 of the carbon offset tracking server 150 may include processors for training and applying machine learning models to determine modes of transport used by a user and/or calculate a carbon offset contribution by the user. The machine learning models may be trained based on reference data (e.g., motion-specific sensor data) associated with a plurality of transportations events having known modes of transportation. The trained machine learning models and associated tools (e.g., regularization parameters, features, weights, neural network architectures, etc.) may be stored in memory 156 (e.g., as ML tools 160).

Furthermore, the memory 156 may store computer-executable instructions that, when executed by the processor 152, may perform one or more functions ascribed to the carbon offset tracking server 150. In some aspects, the memory 156 may store an application program interface 158 that manages, hosts, or otherwise functions as an interface to facilitate communications with user devices via their applications 114.

The carbon offset tracking server 150 may further include a distributed ledger interface 162 for interacting with the distributed ledger 140. For example, the carbon offset tracking server 150 may include a tokenization unit 164 for encrypting and/or masking sensitive data. Furthermore, the carbon offset tracking server 150 may include a verification unit 166 to verify or validate proposed entries (e.g., proposed blocks) into the distributed ledger 140.

The distributed ledger 140 may comprise growing list of records or blocks (e.g., Block 1 142, Block 2 144, Block 3 146, etc.), which may be linked and/or secured using cryptography. Each block may typically comprise a hash pointer as a link to a previous block, a timestamp and transaction data. The blocks may be inherently resistant to modification of the data, such as a recorded carbon offset contribution of an individual user. The distributed ledger may be manage by a network of nodes collectively adhering to a protocol for validating (e.g., verifying) new blocks. In one aspect, the carbon offset tracking server 150 may be a node in the network that manages the distributed ledger 140, and may validate new blocks e.g., via verification unit 166. Once recorded, the data in any given block may not be able to be altered retroactively without the alteration of all subsequent blocks.

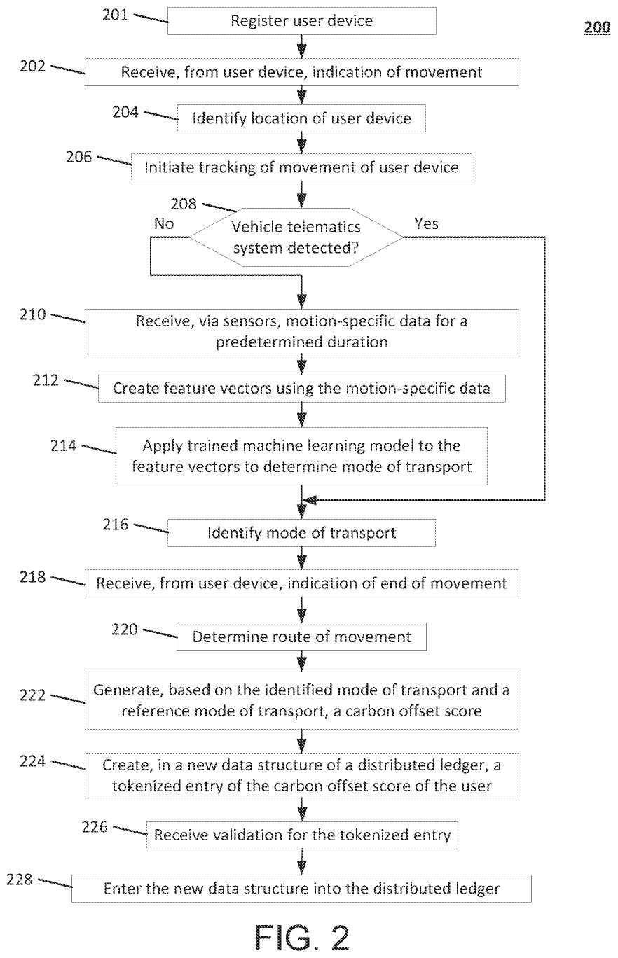

FIG. 2 illustrates an a flow diagram of an example method 200 of tracking individual-based carbon offsets in real time using a distributed ledger, according to exemplary embodiments of the present disclosure. Method 200 may be performed by one or more processors of the carbon offset tracking server 150. Furthermore, while method 200 may concern tracking the carbon offset contribution of a user associated with user device 102 to allow the carbon offset tracking server 150 to record an entry of the user's carbon offset contribution in the distributed ledger 140, method 200 may also apply for other users, via the respective user devices of the other users.

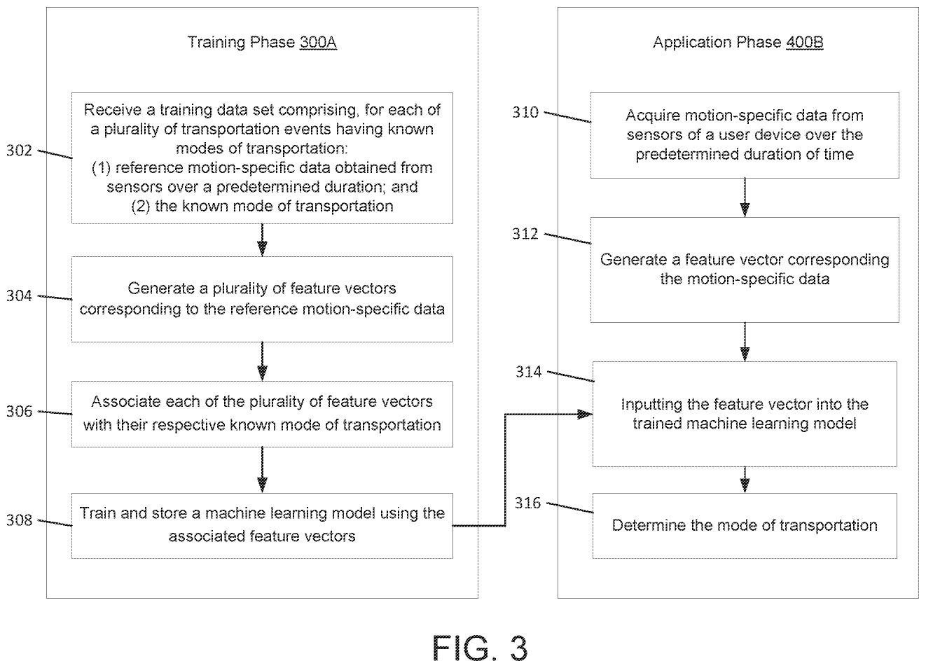

Method 200 may begin by registering a user device associated with a user that intends to track their carbon offsets, e.g., to purchase or avail themselves of carbon credits. As will be further described in FIG. 3, the registration may involve storing an identification of the user device or user at the carbon offset tracking server 150. Furthermore, the registration may involve the carbon offset tracking server 150 requesting and receiving permission to access the user device, e.g., to receive sensor data.

At step 202, the carbon offset tracking server may receive, from a user device (e.g., user device 102), an indication of a movement of the user. For example, the accelerometer 106 may sense an acceleration of the user device 102, prompting an indication that the user is on engaged in transportation activity. Furthermore, to filter out movements that are not related to transportation (e.g., shaking of the smartphone, walking within one's home, etc.), predetermined thresholds may be used such that only sensor readings beyond the predetermined thresholds are deemed as indicating a movement of the user.

At step 204, the carbon offset tracking server 150 may identify a location of the user device. For example, the carbon offset tracking server 150 may use obtain data from the GPS 120 of the user device 102 to geo-locate the user device 102, which may be a reliable indication of the location of the user associated with the user device 102.

At step 206, the carbon offset tracking server 150 may initiate tracking of movement of user device. For example, the carbon offset tracking server 150 may begin receiving, in real time, data obtained from the various sensors 104 (e.g., accelerometer 106, gyroscope 108, magnetometer 110) and/or GPS 120 that may be indicative of the movement of the user device (“motion-specific data”). The motion-specific data may be received at predetermined increments.

Step 208 may include determining whether a vehicle telematics system is detected. For example, the user device 102 may detect, within its vicinity (e.g., personal or local area), the network address of a vehicle telematics system associated with a vehicle, by virtue of the user using the vehicle as a mode of transportation. If detected, the carbon offset tracking server 150 may obtain, via the user device detecting a network identification of the vehicle telematics system, the network identification of the vehicle telematics system. The carbon offset tracking server 150 may thus establish a connection with the vehicle telematics system to obtain information about the vehicle, e.g., to identify the mode of transportation of the user.

Also or alternatively, the carbon offset tracking server may, at step 210, receive motion-specific data for a predetermined duration via sensors of the user device. For example, sensor data from a preset group of sensors (e.g., accelerometer 106, gyroscope 108, and magnetometer 110) over a predetermined group of time may exhibit certain characteristics that are indicative of a mode of transportation. For example, sensor data collected during a bike transportation may exhibit a specific type of acceleration pattern that may be different than that exhibited from sensor data collected during a train transportation.

Step 212 may include creating feature vectors using the motion-specific data. In some aspects, a graph of various motion-specific metrics over time (e.g., acceleration over time) may be used to identify various graphical features (e.g., peaks, slopes, local and global minima, local and global maxima, etc.). The feature vector may be based on the values of any combination of the identified graphical features.

Step 214 may include applying a trained machine learning model to the feature vectors to determine the mode of transport of the user. For example, the feature vector may form an input layer of a neural network architecture having one or more hidden layers and an output layer. More detail regarding the training and application of the machine learning algorithm is described further herein, in relation to FIG. 3. The machine learning model may be used to output a determination of a mode of transport (e.g., bike, train, bus, scooter, etc.).

Thus, at step 216, the carbon offset tracking server 150 may identify the mode of transport, e.g., via the machine learning model and/or via the vehicle telematics system, as described above. In some aspects, a list of modes of transport and their identifying characteristics as it relates to motion-specific data may be saved in memory 156 of the carbon offset tracking server 150. As will be discussed, the identified mode of transport may be useful in determining the carbon offset contribution of the user, e.g., by calculating how much carbon emissions the user avoided by choosing a more eco-friendly mode of transport.

At step 218, the carbon offset tracking server 150 may receive, from the user device, an indication of an end of the movement. For example, the accelerometer 106 of user device 102 may output sensor data indicative of a deceleration in a specific direction. Also or alternatively, the GPS 120 may indicate no shift in the location of the user device 102 for a sustained period of time.

In some aspects, e.g., at step 220, the carbon offset tracking server 150 may determine a route of the movement. A route taken, in contrast to merely calculating the distance between the origin and final point of the movement, may be useful in indicating carbon offset contributions, as using modes of transport over certain types of terrains or environments may be known to offset less carbon than others. The route may be calculated, e.g., via the GPS, or by piecing together various points during the movement, and determining the shortest paths between the points. Also or alternatively, the route may be determined by assessing the navigable paths that the mode of transport is allowed to take.

At step 222, the carbon offset tracking server 150 may generate, based on the identified mode of transport and a reference mode of transport, a carbon offset score. The reference mode of transport may comprise a conventional mode of transport that is known to produce significant carbon emissions (e.g., a gas powered car). The reference mode of transport may thus be an undesirable option for a user seeking to contribute carbon offsets. In some aspects, data regarding carbon emissions released by a reference mode of transport per distance metric (e.g., X pounds CO₂ per mile) may be stored in memory 156 of the carbon offset tracking server 150. In some aspects, the carbon emissions released by the reference mode of transport per distance may vary based on the route taken (e.g., the terrain traversed), and may vary based on weather and environmental factors. The carbon offset tracking server 150 may calculate the carbon emissions that may result if the reference mode of transport had been used over the route of the movement, and may calculate the carbon emissions that may have resulted based on the route of movement taken by the user via the actual mode of transport. In some aspects, the carbon offset score and/or contribution may be based on the difference between the calculated carbon emissions. It is to be appreciated that for certain modes of transport (e.g., biking, running, walking, etc.), the carbon emission may be zero.

At step 224, the carbon offset tracking server 150 may create, in a new data structure of a distributed ledger, a tokenized entry of the carbon offset score of the user. The distributed ledger may be managed by a peer-to-peer network of nodes collectively adhering to a protocol for validating new blocks. In some aspects, the distributed ledger may comprise a blockchain, which may comprise a growing list of records in the form of “blocks,” which may be linked and secured using cryptography. Once a data entry has been recorded in the distributed ledger, the data in any given block cannot be altered retroactively without the alteration of all subsequent blocks, which needs a collusion of the network majority. The tokenization of the carbon offset score may be performed by the tokenization unit 164 of the carbon offset tracking server 150, e.g., to protect sensitive information of the user.

At step 226, the carbon offset tracking server 150 may receive validation for the tokenized entry. For example, computing devices representing other nodes of the distributed ledger network may consent to the entered data being valid.

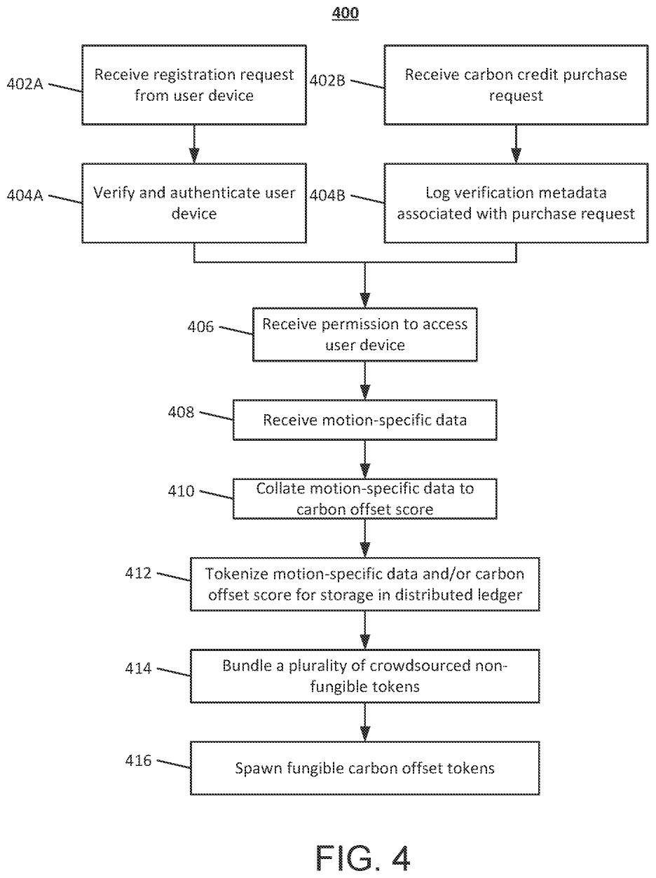

Following the validation, the new data structure may, at step 228, be recorded into the distributed ledger, e.g., as a block. The block may also be linked to the previous block, such that the block cannot be changed without changing other blocks. Thus recording carbon offset contributions of users in a distributed ledger may allow a verifiable, consent-based, and decentralized recognition of individual carbon offset contributions, thus encouraging others to engage in activities to earn the same recognition. Furthermore, as will be further discussed in relation to FIG. 4, the distributed ledger model for recording carbon offset contributions may allow individual contributions towards carbon offsets to be easily aggregated, e.g., for crowdsourcing and/or to spawn fungible tokens (e.g., carbon credits).

FIG. 3 illustrates a flow diagram of example methods for training (e.g., training phase 300A) and application (e.g., application phase 300B) of a machine learning model for tracking individual-based carbon offsets in real time, according to exemplary embodiments of the present disclosure.

The training phase 300A and the application phase 300B may be performed by computing devices having one or more processors, such as carbon offset tracking server 150. In some aspects, the training phase 300A. In some aspects, training phase 300A may be performed by a computing device of a remote server, which may have access to a large repository of reference data for training the machine learning model, while application phase 300B may be performed by a more local computing device.

Training phase 300A may begin by receiving a training dataset (step 302). The training data may comprise, for each of a plurality of transportation events having known modes of transportation: (1) reference motion-specific data obtained from sensors over a predetermined duration; and (2) the known mode of transportation. The training data set may be received from a database that may be periodically updated, e.g., as users continue to log their carbon offset contributions through transportation related decisions and motion-specific data is gained through those transportation decisions.

A plurality of feature vectors corresponding to the reference motion-specific data may be generated at step 304. In some aspects, the plurality of feature vectors may be generated after performing a feature analysis on the training data. For example, motion-specific data that are not related to transportation but are nevertheless detected by the sensors of the user device (e.g., shaking of the smartphone, walking within one's home, etc.) may be filtered out using methods described above. By relying on only pertinent training data, a more robust machine learning model can be developed.

At step 306, the computing device may associate the plurality of feature vectors with their respective known mode of transportation. For example, each feature vector may form an input layer in a neural network architecture, and the corresponding known mode of transport may be indicated in the output layer. In one aspect, the nodes of the output layer may be assigned to each mode of transport of a list of modes of transport. Binary values such as a one or a zero may indicate the known mode of transport. Alternatively, the output layer may indicate a probability values for each mode of transport.

Along with the input layer and the output layer, the neural network may have one or more hidden layers in between, with each layer having one or more nodes. Weights between a node of a given layer and a node of a preceding or succeeding layer may be initialized, e.g., randomly, for the training. Bias units may be used in the convolutional neural network, e.g., to prevent an overfitting of the training data.

At block 308, the computing device may train and store the neural network model using the associated feature vectors. The training of the neural network may include one or more iterations of adjustments of the plurality of weights (e.g., via forward propagation and back propagation of computations through the nodes of each layer). At each iteration, a hypothesized set of adjusted weights may be tested through an error function, e.g., by calculating the difference between nodes of an output layer with the actual outputs (e.g., the values of the known one or more 3D tumor features. In some aspects, the training of the neural network further may include (e.g., during one of the one or more iterations), creating an augmentation dataset comprising the respective nodes of a hidden layer (e.g., the second to last layer of the convolutional neural network). The augmentation dataset (e.g., values of the respective nodes of the second to last layer) may be used to augment the training data set with the augmentation dataset. Augmenting the training dataset with a data from one of the hidden layers can increase the accuracy and reliability of the neural network model at detecting a mode of transport based on received motion-specific data in real time over a predetermined duration. Furthermore, it is contemplated that other forms of machine learning models other than the neural network model may also or alternatively be used. The trained machine learning model may be stored, e.g., in a memory of the computing device, for use during the application phase 300B.

Application phase 300B may begin by acquiring motion-specific data from sensors 104 of the user device 102 (step 310). Like step 212 in FIG. 2, the computing device may then generate a feature vector corresponding to the motion-specific data of the liver tissue of the patient (step 312). For example, graphical features from graphs of various motion-specific metrics (e.g., acceleration, velocity, distance, etc.) over a predetermined duration may be obtained and quantified to produce values for the feature vectors.

At step 314, the computing device may input the feature vector into the trained machine learning model (e.g., from block 308). At step 316, the trained machine learning model may output the mode of transport. As previously discussed the determined mode of transport may be used to calculate the carbon offset contribution of an individual.

FIG. 4 illustrates a flow diagram of an example method 400 of tracking individual-based carbon offsets in real time using a distributed ledger, according to exemplary embodiments of the present disclosure. Method 400 may be performed by a computing device having one or more processors, such as the carbon offset tracking server 150.

Method 400 may begin by receiving a registration request from a user device (step 402A). For example, a user associated the user device 102, after becoming aware of the presently disclosed system for tracking individual-based carbon offsets in real time, may wish to avail the benefits of the system, such as the earning of carbon credits. The user may, e.g., via application 114 of the user device 102, send a registration request to the carbon offset tracking server 150, which may receive the registration request at step 402A.

At step 404A, the carbon offset tracking server 150 may verify and authenticate the user device 102. For example, the user may be asked to enter, into the application 113, a code received from the carbon offset tracking server 150 via text message or a phone call. The carbon offset tracking server 150 may thus, after verifying the user device, store an identification of the user device and/or user.

Also or alternatively, the registration may occur based on a user device sending a request to purchase a carbon credit. For example, at step 402B, the carbon offset tracking server 150 may receive a carbon credit purchase request. At step 404B, the carbon offset tracking server 150 may log verification metadata associated with the purchase request. In some aspects, as a condition for the purchase of carbon credit, the user may be notified to perform activities, such as making better transportation related decisions, to contribute carbon offsets.

At step 406, the carbon offset tracking server 150 may receive permission to access the user device, e.g., to obtain motion-specific data from its sensors 104 and/or GPS 120. In some aspects, the permission to access may be automatically granted as part of a condition for registration. In other aspects, the carbon offset tracking server 150 may send a request for this permission to the user device 102.

After receiving permission, the carbon offset tracking server 150 may, at step 408, receive motion-specific data from the user device 102. The motion-specific data may be received predetermined increments in real time.

Furthermore, at step 410, the carbon offset tracking server 150 may collate the motion-specific data to generate a carbon offset score. As discussed previously, the motion-specific data may be used to determine a mode of transport being used, and the route of movement, both of which may be used to calculate carbon emissions that may have been saved (e.g., based on a comparison with the carbon emissions resulting from taking a conventional gas-powered vehicle over the same route).

At step 412, the carbon offset tracking server 150 may tokenize the motion-specific data and/or the carbon offset score for storage in the distributed ledger 140. The tokenization and storage in the distributed ledger may be performed based on blockchain protocols (e.g., validation, encryption, etc.) explained previously. The stored motion-specific data and/or the carbon offset score may, by virtue of being stored in a distributed ledger platform such as a blockchain, be a verified, immutable proof of an individual's carbon offset contribution.

It may be the case that an individual's carbon offset contribution may still be relatively insignificant to allow the individual to earn a fungible token such as a carbon credit. However, a plurality of non-fungible tokens, such as individual carbon offset contributions, may be bundled to produce a sum that may be significant enough to be a fungible token (e.g., a carbon credit). The bundling may be executed as a result of crowdsourced request from individuals to aggregate their individual carbon offset contributions. In one aspect, individuals may indicate such a request via application 114 (e.g., by opting into a crowdsourced request being circulated to different users).

Thus, at step 414, the carbon offset tracking server 150 may bundle a plurality of crowdsourced non-fungible tokens, e.g., based on such a request. At step 416, the bundled non-fungible tokens may thus spawn fungible carbon offset tokens (e.g., carbon credit(s)).

All of the disclosed methods and procedures described in this disclosure can be implemented using one or more computer programs or components. These components may be provided as a series of computer instructions on any conventional computer readable medium or machine-readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method for tracking individual-based carbon offsets in real time using a distributed ledger, the method comprising:
receiving, in a computing device having one or more processors, and from a user device associated with a user, an indication of a movement from a first location of the user device;
causing, by the computing device via sensors of the user device, the movement of the user to be tracked from the identified first location;
receiving, by the computing device via the sensors, motion-specific data for a predetermined duration that is related to the movement of the user;
creating, by the computing device, one or more feature vectors using the motion-specific data for the predetermined duration;
applying a trained machine learning model to the feature vectors to determine a mode of transport for the movement;
receiving by the computing device, an indication of the end of the movement at a second location;
generating, based on the mode of transport, a carbon offset score; and
creating, in a new data structure of a distributed ledger, a tokenized entry of the carbon offset score, wherein the new data structure is linked to a previous data structure of the distributed ledger.

2. The method of claim 1, further comprising:
receiving, for each of a plurality of transportation events having known modes of transportation, a training data set comprising:
reference motion-specific data over a at least a portion of the respective transportation event; and
the known mode of transportation;
generating a plurality of feature vectors corresponding to the reference motion-specific data;
associating each of the plurality of feature vectors with their respective known mode of transportation; and
training the machine learning model using the associated feature vector.

3. The method of claim 2, further comprising:
eliminating, from the training data set, reference motion-specific data corresponding to motion that is not caused by the known mode of transportation, thereby resulting in an updated reference motion-specific data,
wherein the plurality of feature vectors corresponds to the updated reference motion-specific data.

4. The method of claim 1, further comprising:
determining, based on the first location and the second location, a route of movement, wherein the generating the carbon offset score is further based on the route of movement.

5. The method of claim 4, wherein the generating the carbon offset score comprises:
determining an amount of carbon emissions caused by the mode of transport over the route of the movement; and
comparing the amount of carbon emissions caused by the mode of transport by a reference mode of transport over the route of the movement.

6. The method of claim 1, wherein the computing device is a node in a network associated with the distributed ledger, wherein the creating the tokenized entry of the carbon offset score comprises:
receiving, from other nodes of the network associated with the distributed ledger, a validation of the tokenized entry of the carbon offset score.

7. The method of claim 6, further comprising:
bundling, via the distributed ledger, a plurality of tokenized entries associated with the user, wherein each of the plurality of tokenized entries individually comprises a non-fungible token; and
generating, for the user, and based on the bundling, a fungible carbon offset token.

8. The method of claim 1, wherein the motion-specific data includes one or more of:
an acceleration;
a velocity;
a magnetic orientation; or
an angular velocity.

9. A system for tracking individual-based carbon offsets in real time using a distributed ledger, the system comprising:
the distributed ledger,
one or more processors; and
memory storing instructions that, when executed by the processors, cause the system to:
receive, from a user device associated with a first user, an indication of a movement from a first location of the user device;
initiate, via sensors of the user device, tracking of the movement from the identified first location;
receive, via the sensors, motion-specific data for a predetermined duration;
determine a mode of transport for the movement;
receive an indication of the end of the movement at a second location;
generate, based on the mode of transport, a carbon offset score; and
create, in a new data structure of the distributed ledger, a tokenized entry of the carbon offset score, wherein the new data structure is linked to a previous data structure of the distributed ledger.

10. The system of claim 9, wherein the instructions, when executed, cause the system to determine the mode of transport for the movement by:
creating one or more feature vectors using the motion-specific data for the predetermined duration; and
applying a machine learning model to the feature vectors to determine the mode of transport for the movement.

11. The system, of claim 10, wherein the instructions, when executed, further cause the system to:
receive, for each of a plurality of transportation events having known modes of transportation, a training data set comprising:
reference motion-specific data over at least a portion of the respective transportation event; and
the known mode of transportation;
generate a plurality of feature vectors corresponding to the reference motion-specific data;
associate each of the plurality of feature vectors with their respective known mode of transportation; and
train the machine learning model using the associated feature vector.

12. The system of claim 11, wherein the instructions, when executed, further cause the system to:
eliminate, from the training data set, reference motion-specific data corresponding to motion that is not caused by the known mode of transportation, thereby resulting in an updated reference motion-specific data,
wherein the plurality of feature vectors corresponds to the updated reference motion-specific data.

13. The system of claim 9, wherein the instructions, when executed, cause the system to determine the mode of transport for the movement by:
detecting, via the user device, a vehicle telematics system within a predetermined proximity to the user device; and
determining the mode of transport for the movement using the vehicle telematics system.

14. The system of claim 9, wherein the instructions, when executed, further cause the system to:
determine, based on the first location and the second location, a route of movement, wherein the generating the carbon offset score is further based on the route of movement.

15. The system of claim 14, wherein the instructions, when executed, cause the system to generate the carbon offset score by:
determining an amount of carbon emissions caused by the mode of transport over the route of the movement; and
comparing the amount of carbon emissions caused by the mode of transport by a reference mode of transport over the route of the movement.

16. The system of claim 9, wherein the instructions, when executed, cause the system to create the tokenized entry of the carbon offset score by:
receiving, from one or more computing devices associated with the distributed ledger, a validation of the tokenized entry of the carbon offset score.

17. The system of claim 16, wherein the instructions, when executed, further cause the system to:
bundle, via the distributed ledger, a plurality of tokenized entries associated with the user, wherein each of the plurality of tokenized entries individually comprises a non-fungible token; and
generate, for the user, and based on the bundling, a fungible carbon offset token.

18. A non-transitory computer readable medium for use on a computer system containing computer-executable programming instructions for tracking individual-based carbon offsets in real time using a distributed ledger, the instructions comprising:
receiving, by a computing device having one or more processors and from a user device associated with a user, an indication of a movement from a first location of the user device;
initiating, by the computing device via sensors of the user device, tracking of the movement from the identified first location;
receiving, by the computing device via the sensors, motion-specific data for a predetermined duration;
creating, by the computing device, one or more feature vectors using the motion-specific data for the predetermined duration;
applying a trained machine learning model to the feature vectors to determine a mode of transport for the movement;
receiving by the computing device, an indication of the end of the movement at a second location;
generating, based on the mode of transport, a carbon offset score; and
creating, in a data structure intended for a distributed ledger, a tokenized entry of the carbon offset score.

19. The non-transitory computer readable medium of claim 18, wherein the instructions further comprises:
receiving, for each of a plurality of transportation events having known modes of transportation, a training data set comprising:
reference motion-specific data over a at least a portion of the respective transportation event; and
the known mode of transportation;
generating a plurality of feature vectors corresponding to the reference motion-specific data;
associating each of the plurality of feature vectors with their respective known mode of transportation; and
training the machine learning model using the associated feature vector.

20. The non-transitory computer readable medium of claim 18, wherein the instructions further comprise:
bundling, via the distributed ledger, a plurality of tokenized entries associated with the user, wherein each of the plurality of tokenized entries individually comprises a non-fungible token; and
generating, for the user, and based on the bundling, a fungible carbon offset token.
